(19) United States
(12) Patent Application Publication
(10) Pub. No.: US 2011/0295893 A1
(43) Pub. Date: Dec. 1, 2011

(54) METHOD OF SEARCHING AN EXPECTED IMAGE IN AN ELECTRONIC APPARATUS

(75) Inventor: PENG-FEI WU, Jiangxi (CN)

(73) Assignees: INVENTEC APPLIANCES (SHANGHAI) CO. LTD., Shanghai (CN); INVENTEC APPLIANCES (NANCHANG) CO. LTD., Jiangxi (CN); INVENTEC APPLIANCES CORP., NEW TAIPEI CITY (TW)

(21) Appl. No.: 13/092,070

(22) Filed: Apr. 21, 2011

(30) Foreign Application Priority Data
May 28, 2010 (CN) 201010186140.4

(51) Int. Cl. G06F 17/30

(52) U.S. Cl. 707/776; 707/E17.022

(57) ABSTRACT

A method of searching an expected image in an electronic apparatus comprises the steps of inputting a hand drawing of the expected image into the electronic apparatus; determining whether or not a text description for partially characterizing the expected image is inputted; identifying and searching the expected image in the electronic apparatus according to the hand drawing if the text description is not inputted, or selecting a text label from the text description and interpreting the selected text label by the electronic apparatus if the text description is inputted; and searching a database in the electronic apparatus according to the text label, and fetching the expected image from the database if the value of the image item matches the text label. The hand drawing and/or text label inputted from a mobile phone screen are provided for arranging and searching pictures or images in the database efficiently.

### BACKGROUND OF THE INVENTION

1. Field of the Invention

The present invention relates to a method of browsing and inserting an image in an electronic apparatus, and more particularly to a method of searching an expected image in an electronic apparatus based on the identification and search of a hand drawing and a text label inputted by a user.

2. Description of Related Art

As economic development advances and living standard improves, various communication tools are introduced to provide tremendous convenience in our daily life. More specifically, mobile phones have been expanded from a simple conversation or messaging function to a multifunction that supports multimedia message service (MMS), e-mail and web service, wherein the major features of the MMS include supporting multimedia functions and transmitting contents and information of a large quantity of data to a mobile phone terminal or Internet terminal successfully. For example, the information is multimedia information including images, audio information, video information, data and text and capable of supporting high-speed data operations such as voice, Internet browsing, e-mail and teleconference. In other words, any MMS mobile phone can transmit or receive diversified information contents, and complicated text information, series of black and white or color images, voice or ringtone can be transmitted to others or downloaded into one's mobile phone through MMS, such that dynamic audio/video information content can be transmitted in addition to the simple short text messages.

If a user wants to insert an image in a MMS or e-mail, the user generally need to browse the screen of the mobile pone and search for the image. For a mobile phone with a large storage capacity and many stored images, the browsing and searching processes is troublesome and time-consuming, since most of the image browsing function obtains a target image through visual identification. When a user selects an image, the user can browse images by using direction keys, such as browsing the previous or next photo or image. In addition, if the user wants to search a series of similar images or an image number, the user has to browse all images stored in the mobile phone before the user can know the exact number of photos or image. As a result, the user may spend too much time on browsing unrelated photos or images.

Therefore, it is an important subject for related manufacturers and designers to develop and provide a way of identifying and searching a desired image in a mobile phone quickly to minimize the browsing time.

### SUMMARY OF THE INVENTION

In view of the existing drawbacks of the conventional way of searching an expected image in an electronic apparatus, it is a primary objective of the present invention to provide a method of searching an expected image in an electronic apparatus quickly.

The method of searching an expected image in an electronic apparatus quickly in accordance with the present invention comprises the steps of inputting a hand drawing of the expected image into the electronic apparatus; determining whether or not a text description for partially representing the expected image is inputted, and if no text description is inputted, then the electronic apparatus identifies and searches the image by using the hand drawing, or if a text description is inputted, then the electronic apparatus selects a text label in the text description and interprets the selected text label; searching a database in the electronic apparatus based on the text label if the determination result shows that a text description has been inputted, and fetching the expected image from the database to display and operate the image if the value of the image item is matched with the text label; and searching a database in a priority of the selected and interpreted text label of the text description if both hand drawing and text description are inputted at the same time, and identifying and searching the image by using the hand drawing if the value of the image item does not match the text label.

After the present invention identifies and searches the expected image by using the hand drawing, the search result is recorded into the database.

In the present invention, the expected image is a screen of a picture or a movie.

In the present invention, the value of the image item corresponds to an extensible markup language (XML) file. The image item includes at least one noun text or at least one verb text.

In the present invention, the hand drawing defines a scene of the image, and the scene comprises an image element in a circular, triangular or rectangular shape.

In the present invention, the electronic apparatus is a mobile phone, a personal digital assistant (PDA), a palm computer with a handwriting input function or any other image processing apparatus. If the electronic apparatus is a mobile phone, the method is applicable for inserting the expected image while sending a MMS or an e-mail.

In the method of searching an expected image quickly in accordance with the aforementioned preferred embodiment of the present invention, after a user inputs a simple hand drawing and a declared text label from a mobile phone screen, the user can use the hand drawing and/or the text label to arrange and search a picture or image in a database. Particularly for a search based on the text label, a XML text file corresponding to the text label is used for searching an image in the database with a much higher efficiency than the conventional way of looking up an image by scrolling pages up and down through a mobile phone keypad.

### BRIEF DESCRIPTION OF THE DRAWINGS

FIG. 1 is a schematic view of a hand drawing and a declared text label inputted into a mobile phone by a user;

FIG. 2 is a list of a portion of codes of FIG. 1 according to the schematic description in XML file format;

FIG. 3 is a schematic view of elements for composing each item of an image scene defined by a hand drawing; and

FIG. 4 is a flow chart of a method of searching an expected image quickly in accordance with the present invention.

### DETAILED DESCRIPTION OF THE PREFERRED EMBODIMENTS

With reference to the figures for the illustration of a preferred embodiment of the present invention, the terminologies related to the present invention such as “OpenCV”, “SQLite” and “XML text file” are described one by one to make it easier for those skilled in the art and our examiner to understand the present invention.

Firstly, the Open Source Computer Vision Library (OpenCV) is a cross-platform vision library initiated and developed by Intel and composed of a series of C functions and a small amount of C++ classes to achieve many universal algorithms of image processing and computer vision, so that the OpenCV is used extensively for developing instant image processing, computer vision and pattern recognition program. In addition, the OpenCV not only possesses a cross-platform mid- and high-level application programming interfaces (API) including over 500 C functions, but also uses BSD license to provide free services to both commercial and non-commercial applications. Secondly, the SQLite is a light weighted relational database management system, and the design objective of the SQLite is based on embedded database of files. At present, many embedded products are using the SQLite which occupies very little resources and just requires several hundreds of KB of memory. The SQLite not only is applied to different desktop software for storing user data, but also is used in many consumer electronic apparatuses such as mobile phones, palm computers and MP3 players. In addition, the SQLite can support several mainstream operating systems such as Windows, Linux or UNIX, and combine with different programming languages such as TCL, PHP or JAVA. Compared with MySQL and PostgreSQL database management systems, the SQLite has a faster processing speed.

The eXtensible Markup Language (XML), same as HTML, is a standard generalized markup language (SGML). Specifically, unlike the conventional databases such as Access, Oracle and SQL Server, XML is a simple data storage language that uses a series of simple markup description data, and these databases focus on providing more powerful data storage and data analysis including data index, sorting, lookup and related consistency. The XML simply display data, so that it can write data in any application program easily, implying that the application program can produce information combination with Windows, Mac OS, Linux and other operating platform conveniently and then load XML data into the application program for analysis and output results in the XML format.

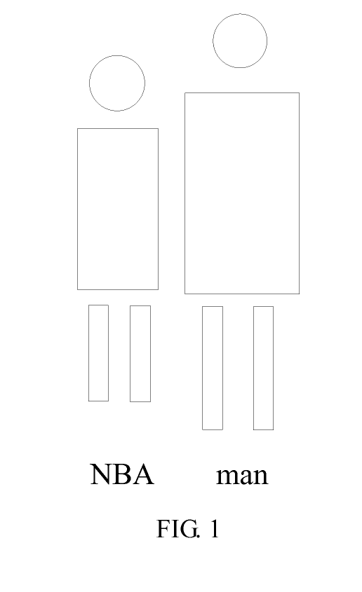

With reference to FIG. 1 for a schematic view of a hand drawing and a declared text label inputted from a mobile phone by a user, the following situation is assumed. The user needs to send a MMS or an E-mail from a mobile phone, and a joint photo of Yao Ming and Tracy McGrady of Houston Rockets stored in the memory of the mobile phone is requested to be inserted to the MMS or the E-mail. In the conventional way, the user generally uses a mechanical keypad of the mobile phone or a stylus to access a corresponding classification menu, and then matches up one after another from the photos until the expected joint photo shows up. If the number of photos is huge, then this searching process gives a very low efficiency and takes much time and effort.

To effectively shorten the time of searching a photo or image in the memory of a mobile phone and assure the accuracy and reliability of the search result, the present invention provides a novel method of searching an expected image quickly. In FIG. 1, the user can input an indicative hand drawing (such as a man's profile) and a declared text label (such as “NBA” and “man”) into the mobile phone. The system searches a user's expected joint photo according to the hand drawing or the text label. In a preferred embodiment of the present invention, a corresponding module of the mobile phone obtains the characteristics of a character according to the inputted hand drawing and matches the characteristics with the image data stored in the memory of the mobile phone through a corresponding algorithm to automatically fetch the expected candidate image. In the meantime, the user's declared text label of the image is used for labeling. In another preferred embodiment of the present invention, the corresponding module of the mobile phone searches an XML text file according to the inputted text label.

Since each XML text file matches with each photo or image file, therefore when a matched XML text file is searched, the expected photo or image can be searched quickly. Persons ordinarily skilled in the art should understand that the recognition speed is slower when the characteristics of the character are used for recognizing an image. In the preferred embodiment of the invention, while the user inputs the hand drawing and the text label at the same searching process, the mobile phone will search the XML text file in the data in priority according to the text label to find the target photo or image quickly and conveniently.

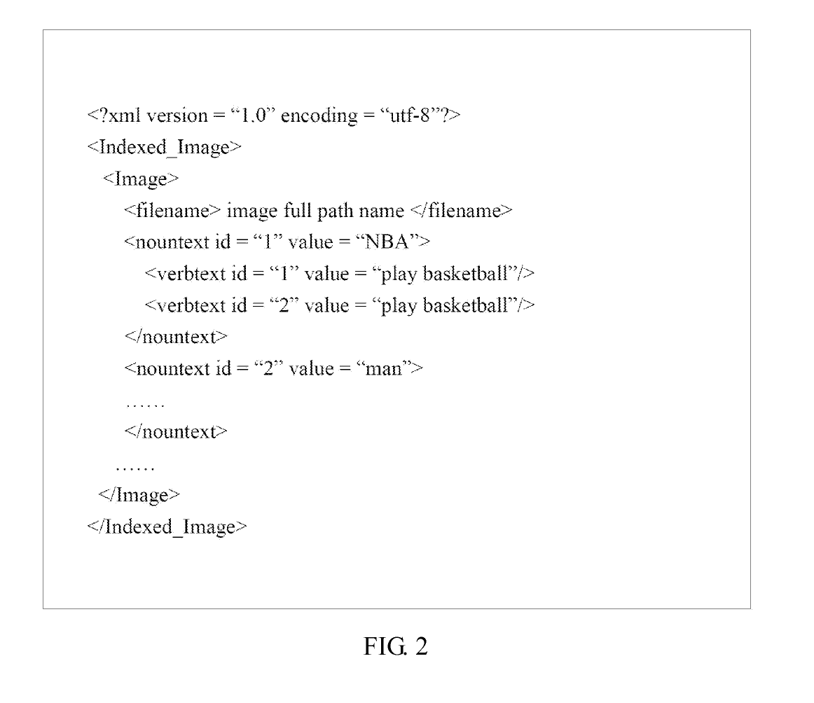

With reference to FIG. 2 for an example of a portion of codes of FIG. 1 according to the schematic description in XML file format, a database is introduced as an index of an image text file in order to match the image text file stored in a memory of a mobile phone with the XML text file. For simplicity, the index of a photo or image is called “Index” and the indexed photo or image is called “Indexed Image”, a photo or image not indexed is called “Non-Indexed Image”. Here, the Index substantially corresponds to an XML text file, and the XML text file is stored in a database to save data and information required by the Index.

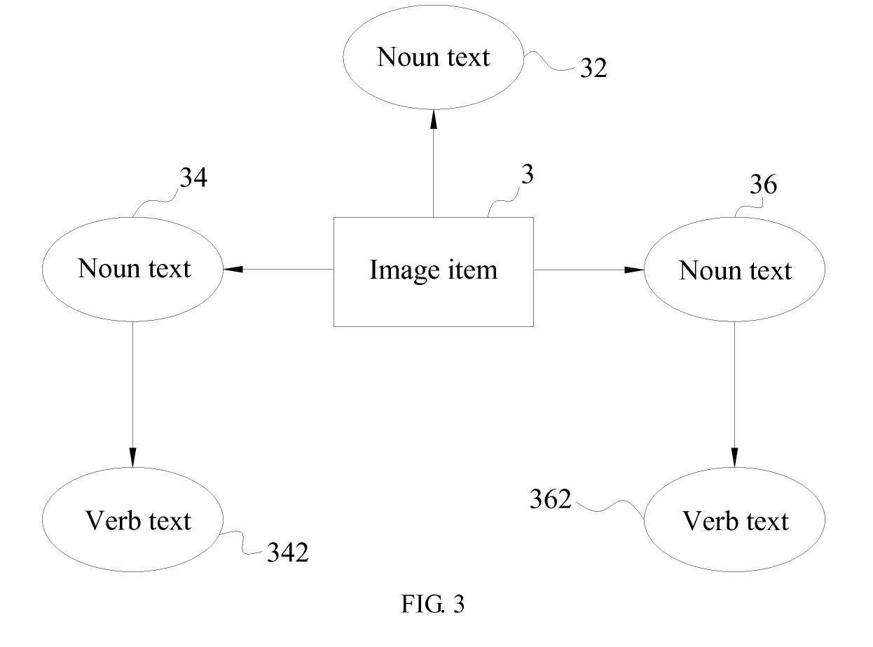

With reference to FIG. 3 for a schematic view of elements for composing each item of an image scene defined by a hand drawing in accordance with a preferred embodiment of the present invention, a hand drawing is inputted to a mobile phone screen by a user and an input functional module of a mobile phone is provided for obtaining the hand drawing from the mobile phone screen, so as to define a scene of a photo or image. Each item in the scene is composed of a series of simple figures, and the Item hereinafter is also called an image element. In FIGS. 1 to 3, three types of image elements are defined in a target photo or image, and they are circular, triangular and rectangular image elements, and users can freely drag the image element to modify the size, shape, combination and layout of an Item. From the description above, the text label corresponding to the XML text file can be used for searching a user's expected photo or image. Similarly, each image element can be used for obtaining the user's inputted text label, and the text label can be used for achieving the search function. In FIG. 3, the image item 3 includes a plurality of noun texts such as a noun text 32, a noun text 34 and a noun text 36, and the number of the noun texts must be greater than or equal to 1. In addition, the noun text may or may not relate to a verb text. For example, the noun text 34 relates to a verb text 342, and the noun text 36 relates to a verb text 362, but the noun text 32 does not relate to any verb text. As to the relation among the image item, noun text and verb text, the partial code list in the XML text file format as shown in FIG. 2 is used for the illustration. In FIG. 2, the image item includes two noun texts, respectively: a first noun text having an identify number equal to “1” and a value equal to “NBA” and a second noun text having an identify number equal to “2” and a value equal to “man”. In addition, the first noun text further relates to a first verb text having an identify number equal to “1” and a value equal to “play basketball” and a second verb text having an identify number equal to “2” and a value equal to “play basketball”.

When a database search is performed, the filename of the image is defined as an index ID (also known as a Key) and the XML text file of the image is defined as a Value, wherein the Key and Value constitute an Item. If the database has a value of a certain Item matched with a user's inputted text label, then the image corresponding to the Item is confirmed as the expected image searched by the user. If the database has no value of any Item matched with the user's inputted text label, then it is necessary to recognize and search an image according to the user's inputted hand drawing and record the search result into the database.

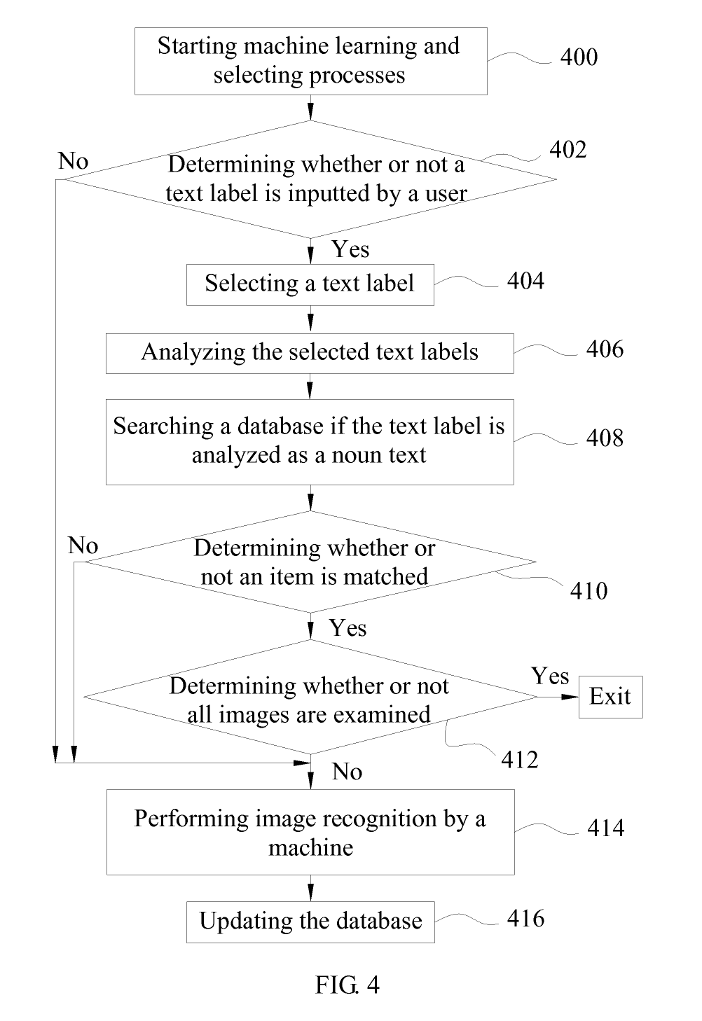

To more specifically describe the method of searching an expected image quickly in accordance with the present invention, a flow chart as shown in FIG. 4 is provided for the detailed description of the method of searching an image according to a hand drawing and a text label inputted by a user, the method comprises the following steps:

In Step 400, machine learning and selecting processes are started. In Step 402, whether or not a text label is inputted by a user is determined; if the user dose not inputted any text label, then go to Step 414, an inputted hand drawing is used to search and recognize all image text files, such as using OpenCV to recognize images; and if the user has inputted a text label, then go to Steps 404 and 406 to select the text labels sequentially and analyze the selected text labels. In Step 408, if the text label is analyzed as a noun text, then such noun text is used to search a database such as a SQLite database, and go to Step 410 to determine whether an item of the database is matched. If the item is not matched, then go to Step 414; and if the item is matched, then go to Step 412 to further determine whether or not the examination is completed. If the determination result shows that all images have been examined, then the procedure is exited; and if the determination result shows that not all of the images have been examined, then go to Step 414. After the machine is used for recognizing the images, go to Step 416 to update the recognition result to a database.

In addition, when the procedure determines that not all images are examined in Step 412, the procedure can further continue examining the non-indexed image text file, and then go to Step 414. Persons ordinarily skilled in the art should understand that when the text label is used for matching the item, the indexed image text file in the database is searched with priority, and the image text file substantially corresponds to an XML text file.

In a preferred embodiment of the present invention, a hand drawing and a text label inputted by a user are used for searching an expected image quickly, and such method can expedite the editing of the inserted image when sending a MMS. In another preferred embodiment of the present invention, a hand drawing and a text label inputted by a user are used for searching an expected image quickly, and such method also can expedite the editing when the user needs to add an image when sending an E-mail.

In the aforementioned preferred embodiment of the present invention, the mobile phone sending out a MMS or E-mail is used as an example for illustrating the method of searching an expected image quickly, but the present invention is not limited to such example only, but the method can also be applied to a personal digital assistant (PDA), a palm computer with a handwriting input function, or any image processing apparatus, and such application is intended to be covered by the scope of the present invention.

In the method of searching an expected image quickly in accordance with the present invention, after a user inputs a simple hand drawing and a declared text label through a mobile phone screen, the hand drawing and/or the text label can be used for arranging and searching pictures and images in the database. Particularly, for the search based on the text label, the XML text file corresponding to the text label can be used for searching the images in the database with a much higher efficiency than using the mobile phone keypad to scroll pages up and down to search an image.

While the invention has been described by means of specific embodiments, numerous modifications and variations could be made thereto by those skilled in the art without departing from the scope and spirit of the invention set forth in the claims.

What is claimed is:

1. A method of searching an expected image in an electronic apparatus, comprising the steps of:
inputting a hand drawing of the expected image into the electronic apparatus;
determining whether or not a text description for partially characterizing the expected image is inputted;
identifying and searching the expected image in the electronic apparatus according to the hand drawing if the text description is not inputted, or selecting a text label from the text description and interpreting the selected text label by the electronic apparatus if the text description is inputted; and
searching a database in the electronic apparatus according to the text label, and fetching the expected image from the database if a value of an image item matches the text label.

2. The method of searching an expected image in an electronic apparatus as recited in claim 1, wherein the database is searched in a priority of the selected and interpreted text label of the text description if both the hand drawing and the text description are inputted at the same time, and the hand drawing is used for identifying and searching the image if the value of the image item does not match the text label.

3. The method of searching an expected image in an electronic apparatus as recited in claim 2, wherein a search result is recorded into the database after the hand drawing is used for identifying and searching the image.

4. The method of searching an expected image in an electronic apparatus as recited in claim 2, wherein the expected image is a screen of a picture or a movie.

5. The method of searching an expected image in an electronic apparatus as recited in claim 2, wherein the value of the image item corresponds to an extensible markup language (XML) file.

6. The method of searching an expected image in an electronic apparatus as recited in claim 2, wherein the image item includes at least one noun text or at least one verb text.

7. The method of searching an expected image in an electronic apparatus as recited in claim 2, wherein the hand drawing defines a scene of the image, and the scene comprises an image element in a circular, triangular or rectangular shape.

8. The method of searching an expected image in an electronic apparatus as recited in claim 2, wherein the electronic apparatus comprises a mobile phone, a personal digital assistant, a palm computer with a handwriting input function, or an image processing apparatus.

9. The method of searching an expected image in an electronic apparatus as recited in claim 8, wherein the method is applicable for inserting the expected image while sending a MMS file or an e-mail, if the electronic apparatus is a mobile phone.

10. The method of searching an expected image in an electronic apparatus as recited in claim 1, wherein the expected image is a screen of a picture or a movie.

11. The method of searching an expected image in an electronic apparatus as recited in claim 1, wherein the value of the image item corresponds to an extensible markup language (XML) file.

12. The method of searching an expected image in an electronic apparatus as recited in claim 1, wherein the image item includes at least one noun text or at least one verb text.

13. The method of searching an expected image in an electronic apparatus as recited in claim 1, further comprising a step of displaying or operating the expected image.

14. The method of searching an expected image in an electronic apparatus as recited in claim 1, wherein the hand drawing defines a scene of the image, and the scene comprises an image element in a circular, triangular or rectangular shape.

15. The method of searching an expected image in an electronic apparatus as recited in claim 1, wherein the electronic apparatus comprises a mobile phone, a personal digital assistant, a palm computer with a handwriting input function, or an image processing apparatus.

16. The method of searching an expected image in an electronic apparatus as recited in claim 15, wherein the method is applicable for inserting the expected image while sending a MMS file or an e-mail, if the electronic apparatus is a mobile phone.
